(19) United States
(12) Patent Application Publication
(10) Pub. No.: US 2018/0320047 A1
(43) Pub. Date: Nov. 8, 2018

(54) COOLANT CONCENTRATE CONTAINING SILICATE

(71) Applicant: ROWE Holding GmbH, Flörsheim-Dalsheim (DE)

(72) Inventor: Stefan Berger, Worms (DE)

(21) Appl. No.: 15/773,279

(22) PCT Filed: Nov. 10, 2016
(86) PCT No.: PCT/DE2016/000395

§ 371 Date: May 3, 2018

(30) Foreign Application Priority Data
Nov. 11, 2015 (DE) 10 2015 014 480.4

(51) Int. Cl. C09K 5/20; C09K 5/10; C23F 11/04

(52) U.S. Cl. CPC C09K 5/20; F24S 80/20; C23F 11/04; C09K 5/10

(57) ABSTRACT

The invention relates to a silicate-containing coolant concentrate, including at least one freezing-point lowering liquid, at least one mixture of at least two saturated, aliphatic dicarboxylic acids, at least one saturated aliphatic or hydroxyl-containing aromatic mono-carboxylic acid, at least one azole, at least one stabilizing silicate, at least one phosphonocarboxylic acid, and at least one heteropoly complex anion from the group IIIA to VIA of the periodic table of the elements.

The present invention relates to a silicate-containing coolant concentrate and to a use of the coolant concentrate.

Coolant concentrates for the cooling cycle of combustion engines, for example in motor vehicles, mainly consist of a freezing point lowering liquid, in particular ethylene glycol or propylene glycol. Before being used, these liquids are usually mixed 1:1 v/v % with water in order to lower the freezing point. Since glycol water mixtures are corrosive, various corrosion inhibitors are added to the mixtures.

Coolant compositions are known from DE 101 28 530 A1, DE 196 25 692 A1, DE 699 05 072 T2, EP 0 863 960 B1, US 2014/0224193 A1 and U.S. Pat. No. 6,413,445 B1.

Nowadays, corrosion inhibits must fulfil a variety of demands. They must be effective at low concentrations and they must not pose any toxicological or environmentally-dangerous effects. All materials present in the cooling cycle, such as iron, copper, brass, brazing solder, aluminum and aluminum alloys as well as non-metal components such as elastomers must be reliably protected against different forms of corrosion even at high thermal stress. The plurality of metals in the cooling cycle leads to potential corrosion problems, in particular if metals are in an electrically-conductive contact with one another. In these places, selective corrosion, contact corrosion, crevice corrosion, surface corrosion, pit corrosion or cavitation can occur.

The presence of corrosion products in the cooling cycle can impede the heat transfer from the engine to the cooling liquid, which necessarily results in an overheating of the engine and component failure.

As a consequence of the ever-increasing peak temperatures, heavy temperature changes and higher flow rates along with a reduction of the coolant volume, nowadays, ever higher demands are made to the thermal stability of the coolant.

In order that passenger cars and trucks can meet the legal environmental regulations of a reduced pollutant emission and have a reduced fuel consumption at the same time, automobile manufacturers fabricate a plurality of components of the cooling cycle of light metals such as aluminum and its alloys.

Typical components in heat exchangers are, for example, tubes, through which the coolant flows and in which the heat exchange occurs, or the lamellae between the tubes for the dissipation of heat to the surroundings.

Automotive heat exchangers made of aluminum or aluminum alloys are predominantly manufactured in accordance with the Controlled Atmosphere Brazing (CAB) process. By contrast with other soldering methods, these processes provide the advantage that the formation of aluminum oxide does not occur, that it is particularly cost-effective and produces high-quality products at the same time. Typically, the components are assembled through the formation of a metallurgical bond by means of a solder, the melting point of which is lower than that of the material itself.

In order to remove the aluminum oxide protective layer natural to the process, a flux is applied to the metal surface, so that the solder can flow freely. Typically, mixtures containing potassium fluoroaluminate of the formula K₁₋₃AlF₄₋₆, which are known by the trade name of NOCOLOK®, are used as a flux.

However, during operation, flux residues can detach from the components, through which the coolant flows, and get into the cooling system. Although fluoride-containing fluxes are considered to be non-corrosive towards aluminum, corrosion problems tend to occur at regular intervals.

Alkaline metal silicates have proven to be particularly effective corrosion inhibitors for aluminum components, which, per se, are added to the coolants. It is assumed that silicates form a contiguous, monomolecular, corrosion-inhibiting protective layer on the metal surface.

However, silicates tend to fail in the presence of flux residues and to irreversibly form gel-like precipitates in polymerization reactions. These precipitates result in clogged cooler lamellae, in that the heat transfer from the materials in the cooling system into the heat carrier fluid are impeded and thus the engine overheats, the water pump is damaged or other engine damages occur.

These effects can be observed, in particular, when the silicate content in the cooling systems has significantly dropped below 30 ppm. As the number of aluminum components in the cooling cycle constantly increased in recent years, the demand for flux-resistant, stabilized, silicate-containing, organic coolant technologies, the so-called Si-OAT, increases more and more on the side of the automobile industry.

Therefore, there is a demand to provide a coolant on a Si-OAT basis, which has a high resistance against flux residues and in which the silicon content, in the presence of a flux, remains almost unchanged even with high thermal stress.

The object of the present invention is to provide a coolant on an Si-OAT basis, which has a high resistance against flux residues even with high thermal stress and thus reduces or prevents the formation of Al—O—Si compounds and hardly soluble Al(OH)₃.

The object of the present invention is achieved by a silicate-containing coolant concentrate, including
at least one freezing-point lowering liquid,
at least one mixture of at least two saturated, aliphatic dicarboxylic acids,
at least one saturated aliphatic or hydroxyl-containing aromatic mono-carboxylic acid,
at least one azole,
at least one stabilizing silicate,
at least one phosphonocarboxylic acid, and
at least one heteropoly complex anion from the group IIIA to VIA of the periodic table of the elements, such as boron, aluminum, gallium, indium, thallium, carbon, silicon, germanium, tin, lead, nitrogen, phosphor, arsenic, antimony, bismuth, oxygen, sulfur, selenium, tellurium.

The pH value of the coolant concentrate is between 7 and 9.5, its water value according to Karl Fischer is below 3%, and the silicon content is approximately at 200 ppm to 300 ppm. The use of the coolant is not limited to closed cooling cycles in passenger cars and trucks, but can also be used in open cooling cycles such as central heating etc.

The silicate-containing coolant concentrate has a plurality of advantages: it has a good flowability, a high stability, in particular a good temperature stability, as required in motor vehicles having a high horse power, as the engines get very hot here, it is particularly well suitable for the non-ferrous metal inhibition, such as copper, and it offers a goods aluminum corrosion protection, since silicate serves the aluminum protection; here, the silicate is stabilized, since, otherwise, precipitation occurs, and thus clogging of the cooling system.

The freezing point lowering liquid serves to lower the freezing point of the (coolant) liquid.

In the following, the composition of a silicate-containing coolant, respectively a heat carrier fluid, is described, which comprises a particularly high flux compatibility of the ingredients.

In a coolant or a heat carrier fluid consisting of a freezing point lowering component, two different saturated, aliphatic dicarboxylic acids, one monocarboxylic acid, one azole, and a commercially available stabilized silicate, a higher flux compatibility of aluminum and aluminum alloys is achieved through the use of a heteropoly complex anion in combination with a phosphonocarboxylic acid.

This effect was tested using modified ASTM D4340 corrosion tests at 150° C. for 168 hours using flux-containing water and subsequent measuring of the corrosion rate in mg/cm₂/week and measuring of the silicon content in ppm.

The silicate-containing coolant concentrate contains 0.1 weight percent to 2 weight percent of a saturated, aliphatic or aromatic monocarboxylic acid having six to 12 carbon atoms (C6 to C12). Typical members of the class of saturated aliphatic monocarboxylic acids are pentanoic acid, hexanoic acid, 2-ethyl hexanoic acid, n-heptanoic acid, octanoic acid, nonanoic acid, isocyanic acid, decanoic acid, undecanoic acid, dodecanoic acid.

The monocarboxylic acid functions as a rust protection, since the monocarboxylic acid is present as a carboxylation and attaches to the metal surface, so that the electrolyte does not reach the metal surface (metal surface of the cooler or cooling system).

The hydroxyl group containing, aromatic carboxylic acids concern carboxylic acids derived from the benzoic acid. They comprise one or two hydroxyl groups. Suitable hydroxyl group containing, aromatic monocarboxylic acids are 2- or 3-hydroxybenzoic acid, and in particular 4-hydroxybenzoic acid or 2-, 3- or 4-(hydroxymethyl)benzoic acid.

The concentrate contains at least one azole as additive. Typical examples are tolyltriazole, hydrated tolyltriazole, methylbenzotriazole, butylbenzotriazole, 1H-1,2,4-triazole, benzotriazole, benzothiazole, 2-mercaptobenzthiazole, substituted thiazoles, imidazoles, benzimidazoles, indazoles, tetrazoles, (2-benzothiazylthio)-acetic acid. 0.01 weight percent to 0.5 weight percent with respect to the total amount of the concentrate of azoles are contained in the coolant concentrate. Combinations of two or more of the above-mentioned compounds can be used as well and are also comprised by the term azole.

Appropriately, the coolant concentrate contains 0.01 weight percent to 0.06 weight percent, with respect to the total amount of the concentrate, of a stabilizing silicate. The silicate is stabilized in common amounts through silicate stabilizers.

Suitable silicates are those of the type (MO)ₘSiO_{(4n/2)}(OH)ₚ, in which M is a monovalent cation from the group of lithium, sodium, potassium, rubidium, or tetraorganoammonium, m is from 1 to 4, n is from 1 to 4 and p is from 0 to 3, with m+p=n. Examples thereof include potassium metasilicate, sodium orthosilicate, potassium disilicate, sodium metasilicate, potassium metasilicate, lithium metasilicate, lithium orthosilicate, rubidium disilicate, rubidium tetrasilicate, mixed salts, tetramethyl ammonium silicate, tetra ethyl ammonium silicate, ammonium silicate, tetra hydroxyethyl ammonium silicate. Suitable are likewise organic silicate esters of the type Si(OR)₄, in which R can be an alkyl-, aryl-, or hydroxyalkyl group between C1 and C36. However, appropriately, alkaline metal metasilicates are used.

Organosilanes such as Silquest Y-5560 or Silan AF-1, sodium-(trihydroxysilyl)propymethylphosphonate such as Xiameter® Q1-6083, alkaline metal amoniphosphonates, organic phosphosilicones of the type (O_{1,5}Si—C₃H₆)—P(O)(O⁻Na⁺)(OC₂H₅), as described in U.S. Pat. No. 4,629,602, polyacrylic acids, methyl cellulose, or borates can be used as silicate stabilizer.

The freezing point lowering liquid is preferably a compound of the group including alkylene glycols, alkylene glycol ethers, glycol ethers, glycerin, or a mixture of two or more of these compounds. As members of this class, Monoethylene glycol, monopropylene glycol, diethylene glycol, dipropylene glycol, triethylene glycol, tripopylene glycol, tetraethylene glycol, methyl ester, ethyl ester, propyl ester, butyl ester are used. Monoethylene glycol is particularly suitable.

The dicarboxylic acid preferably has a chain length between four and 12 carbon atoms (C4 to C12), since carboxylic acids having chain lengths of more than 12 carbon atoms are not soluble.

Appropriately, a mixture of two different saturated aliphatic dicarboxylic acids with four to 12 carbon atoms (C4 to C12) is used. Typical members of the dicarboxylic acids include malonic acid, succinic acid, glutaric acid, adipic acid, pimelic acid, suberic acid (C₈H₁₄O₄), azelaic acid, sebacic acid, undecanoic acid, dodecanoic acid, terephthalic acid, dicyclopentadiene dicarboxylic acid. Particularly good results are obtained with a mixture of adipic acid and sebacic acid.

Preferably, the dicarboxylic acids and/or the monocarboxylic acids are present in the form of their alkaline or alkaline earth metal salts. Sodium and potassium slats are particularly suitable. If a mixture of the adipic acid and sebacic acid as dicarboxylic acids is used, either both of them are used in the form of the dipotassium salt, or the sebacic acid as disodium salt and the adipic acid as dipotassium salt.

At least one phosphonocarboxylic acid or mixtures thereof are used as further additives. The term phosphonocarboxylic acid includes both the free carboxylic acids and the carboxylates. Examples thereof include phosphono-succinic acid, 1,2,3,4,5,6-hexacarboxyhexane (1,2,3,4,5,6-hexaphosphonocarboxyhexane), 1-hydroxy-1,1-diphosphonic acid (1-hydroxy-1,1-diphosphonocarboxylic acid), 1-phosphono-1,2,3,4-tetraphosphonic acid (1-phosphono-1,2,3,4-tetraphosphonic carboxylic acid), amino-trimethyl-phosphonic acid, phosphonic acid (phosphonocarboxylic acid), 2-phosphonobutane-1,2,4-tricarboxylic acid, 1-phosphono-1-hydroxy acetic acid, hydroxymethyl-phosphonic acid and others. The content with respect to the total amount of the concentrate is between 0.01 weight percent and 0.5 weight percent.

The coolant concentrate contains, as an additive, between 0.01 weight percent to 1 weight percent with respect to the total amount of the concentrate, of at least one heteropoly complex anion from the group IIIA to VIA of the periodic table of the elements.

In a preferred embodiment of the invention, the heteropoly complex anion is a molybdate anion.

Particularly preferably, the heteropoly complex anion is an anion from the group including phospho-molybdates, silicon molybdates, manganese molybdates, silicon tungstates, tellurium molybdates, arsenic molybdates, or a mixture of two or more of these compounds.

Preferably, the heteropoly complex anion is a phosphomolybdate of the formula (PMo₁₂O₄₀)³⁻.

The phosphono carboxylic acid preferably is 2-phosphonobutane-1,2,3-tricarboxylic acid.

In a preferred embodiment of the invention, the coolant concentrate contains a pH-adjusting component. The pH-adjusting component serves to adjust the pH value of the coolant. Suitable pH-adjusting components are compounds such as caustic potash, caustic soda, or sodium phosphate.

The pH value of the silicate-containing, flux-resistant coolant concentrate is preferably in the range between 6 and 10, and, in particular, in the range between 7.5 and 8.5. Here, the desired pH value can be adjusted by adding alkaline metal hydroxide to the (coolant concentrate) formulation. Appropriately, the aliphatic carboxylic acids are used in the form of their alkaline metal salts, so that the pH value of the formulation reaches the desired range on its own. However, alternatively, it is also possible to use the free (carboxylic) acids, which are neutralized with alkaline metal hydroxide. The most suitable are sodium hydroxide or potassium hydroxide or aqueous caustic potash or caustic soda.

Finally, up to 0.5 weight percent with respect to the total amount of the concentrate of one or multiple hard water stabilizers on the basis of polyacrylic acid, poly-maleic acid, acrylic acid maleic acid copolymers, polyvinylpyrrolidone, polyvinyllimidazole, vinylpyrrolidone-vinylimidazole-copolymers and/or copolymers of unsaturated carboxylic acids and olefins can be present. However, low-molecular substances such as 2-phosphonobutane-1,2,4-tricarboxylic acids are preferably used.

Furthermore, the coolant concentrate (or the heat carrier fluid) can contain corrosion inhibitors such as pH buffers, straight-chained, branched or aromatic monocarboxylic acids, dicarboxylic acids, tricarboxylic acids, molybdates, borates, nitrides, amines, phosphates, or silicones.

Little amounts of defoamers, usually between 0.001 weight percent and 0.02 weight percent, individual or multiple colorants, and bittern as an anti-swallowing measure can be assessed to the coolant concentrate as further additives. One example for a bittern is denatonium benzoate, which is commercially available under the trade name of Bitrex®.

In a preferred embodiment of the invention, the coolant concentrate includes
more than 90 weight percent with respect to the total amount of the concentrate of at least one freezing point lowering liquid,
1.5 to 5 weight percent with respect to the total amount of the concentrate of at least one mixture of at least two saturated, aliphatic dicarboxylic acids,
0.1 to 1 weight percent with respect to the total amount of the concentrate of at least one saturated, aliphatic or hydroxyl-containing, aromatic monocarboxylic acid,
0.05 to 0.5 weight percent with respect to the total amount of the concentrate of at least one azole,
0.01 to 0.06 weight percent with respect to the total amount of the concentrate of at least one stabilizing silicate,
0.01 to 1 weight percent with respect to the overall amount of the concentrate of at least one phosphonocarboxylic acid, and
0.01 to 1 weight percent with respect to the total amount of the concentrate of at least one heteropoly complex anion from the group IIIA to VIA of the periodic table of the elements.

Furthermore, the object of the present invention is achieved by a use of the coolant concentrate, as a heat carrier fluid, for the cooling of a combustion engine, a solar plant or a refrigerator.

Due to the flux resistance of the coolant concentrate, it is particularly suitable for the use in coolers or cooling systems of combustion engines, for example of motor vehicles.

Through the use of non-poisonous, freezing point-lowering liquids such as propylene glycol, the silicate-containing coolant concentrate can also be used in the food industry.

Hereinafter, the invention will be described in greater detail by means of examples.

The silicon-containing, nitride-, nitrate-, borate- and amine-free coolant concentrate for combustion engines described here, based on a mixture of carboxylic acids, azoles, phosphono-carboxylic acid, as well as at least one heteropoly complex anion from the group IIIA to VIA of the periodic table of the elements, alkylene glycols, or their derivatives.

Further possible ingredients of the silicate-containing coolant concentrate are, for example, sabit and/or thiopropionic acid, which function as copper inhibitors.

Silicate provides an excellent corrosion protection in particular for aluminum and its alloys. Thus, in silicate-containing coolants, it is to be prevented that a reduction of the silicate or silicon content occurs, since otherwise the corrosion protection is affected.

The coolant concentrate has an increased thermal stability and an increased compatibility towards flux residues.

### Comparative Test:

Modified ASTM D4340 corrosion tests were performed with various silicate-containing coolants. In each case, 250 ml coolant were mixed with in each case 250 ml NOCOLOK® water (2000 mg/1), the initial silicon content was determined through AAS (atomic absorption spectroscopy), and, subsequently, the coolants were heated to 150° C. for 8 hours in the test apparatus, which simulates a hot surface of a cylinder head made of aluminum in a combustion engine. Once the coolants reached room temperature again, 5 ml of each coolant was filtrated with a 0.45 μl filter and, subsequently, the silicon content was determined again. The following table shows representative examples for the coolant compositions as well as the decrease in the silicate content on percent over the test period of 8 h.

| | Coolant 1 | Coolant 2 | Coolant 3 | Coolant 4 |
|---|---|---|---|---|
| | (in weight | (in weight | (in weight | (in weight |
| Component | percent) | percent) | percent) | percent) |
| Monoethylene glycol | 91.02 | 90.64 | 93.34 | 92.24 |
| Caustic potash (45%) | 4.62 | 5.60 | 3.00 | 3.40 |
| 2-ethyl-hexane acid | — | — | 3.20 | 3.00 |
| Sebacic acid | 3.00 | 0.40 | 0.20 | — |
| Hydroxy-benzoic acid | 0.40 | — | — | — |
| Adipic acid | 0.30 | 3.00 | — | 0.30 |
| Isononanoic acid | — | — | — | 0.40 |
| Tolyltriazole | 0.20 | — | 0.10 | 0.10 |
| Benzotriazole | — | 0.20 | — | 0.10 |
| Heteropoly complex | 0.30 | — | — | 0.30 |
| anion | | | | |
| Sodium metasilicate | 0.16 | 0.16 | 0.16 | 0.16 |
| pentahydrate | | | | |
| Silicon content (ppm, | 117 | 124 | 120 | 112 |
| start) | | | | |
| Silicon content (ppm, | 100 | 32 | 25 | 90 |
| end) | | | | |
| Δ Si (%) | 15 | 75 | 80 | 20 |

All coolants shown in the table contain the same amount of silicon in the form of alkaline metal silicates, i.e. 0.16 weight percent. Coolants 1 and 4 are silicate-containing coolant concentrates according to the present invention.

As can be seen in the table, the reduction of the silicon content in the coolant (A Si [%]), and thus the reduction of the silicate content in the coolant, is significantly smaller in coolants 1 and 4 than in coolants 2 and 3, which do not contain a heteropoly complex anion.

1. A silicate-containing coolant concentrate, including
at least one freezing-point lowering liquid,
at least one mixture of at least two saturated, aliphatic dicarboxylic acids,
at least one saturated aliphatic or hydroxyl-containing aromatic mono-carboxylic acid,
at least one azole,
at least one stabilizing silicate,
at least one phosphonocarboxylic acid, and
at least one heteropoly complex anion from the group IIIA to VIA of the periodic table of the elements.

2. The coolant concentrate according to claim 1, wherein the freezing point lowering liquid is a compound of the group including alkylene glycol, alkylene glycol ether, glycol ether, glycerin, or of a mixture of two or more of these compounds.

3. The coolant concentrate according to claim 1, wherein the dicarboxylic acids have a chain length between four and 12 carbon atoms.

4. The coolant concentrate according to claim 1, wherein the dicarboxylic acids and/or the monocarboxylic acids are present in the form of their alkaline or alkaline earth metal salts.

5. The coolant concentrate according to claim 1, wherein the heteropoly complex anion is a molybdate anion.

6. The coolant concentrate according to claim 1, wherein the heteropoly complex anion is an anion from the group including phosphomolybdates, silicon molybdates, manganese molybdates, silicon tungstates, tellurium molybdates, arsenic molybdates, or a mixture thereof.

7. The coolant concentrate according to claim 1, wherein the heteropoly complex anion is a phosphomolybdate of the formula (PMo₁₂O₄₀)³⁻.

8. The coolant concentrate according to claim 1, wherein the phosphonocarboxylic acid is 2-phosphonobutane-1,2,4-tricarboxylic acid.

9. The coolant concentrate according to claim 1, wherein a pH-adjusting component is contained.

10. The coolant concentrate according to claim 1, wherein the pH value of the concentrate is in the range between 6 and 10.

11. The coolant concentrate according to claim 1, including
more than 90 weight percent with respect to the total amount of the concentrate of at least one freezing point lowering liquid,
1.5 to 5 weight percent with respect to the total amount of the concentrate of at least one mixture of at least two saturated aliphatic dicarboxylic acids,
0.1 to 1 weight percent with respect to the total amount of the concentrate of at least one saturated, aliphatic or hydroxyl-containing aromatic monocarboxylic acid,
0.05 to 0.5 weight percent with respect to the total amount of the concentrate of at least one azole,
0.01 to 0.06 weight percent with respect to the total amount of the concentrate of at least one stabilizing silicate,
0.01 to 1 weight percent with respect to the overall amount of the concentrate of at least one phosphonocarboxylic acid, and
0.01 to 1 weight percent with respect to the total amount of the concentrate of at least one heteropoly complex anion from the group IIIA to VIA of the periodic table of the elements.

12. Use of a coolant concentrate according to claim 1 for the cooling of a combustion engine, a solar plant or a refrigerator.
